(19) United States
(12) Patent Application Publication
(10) Pub. No.: US 2014/0266804 A1
(43) Pub. Date: Sep. 18, 2014

(54) PARKING TRACKING SYSTEM

(71) Applicant: Kamran ASADPOUR, Davis, CA (US)

(72) Inventor: Kamran ASADPOUR, Davis, CA (US)

(21) Appl. No.: 13/841,164

(22) Filed: Mar. 15, 2013

(51) Int. Cl. G08G 1/14

(52) U.S. Cl. CPC G08G 1/141
USPC 340/932.2

(57) ABSTRACT

An example embodiment includes a method including tracking vehicles entering and exiting a parking area based on radio frequency identification (RFID) signals received from RFID tags included in the vehicles associated with the parking area. The method also includes determining parking area information associated with the parking area based on the RFID signals. The method further includes providing, via a network, the parking area information to at least one of a parking administrator of the parking area and a user registered to park in the parking area.

### FIELD

The embodiments discussed herein are related to a parking tracking system.

### BACKGROUND

In parking areas, such as those bordering universities and large employment centers, signs may be posted that indicate who may park in a particular sub-region of the parking area. For example, a first sub-region of a parking area may have an “A” parking sign that indicates users having an “A” parking permit may park in the first sub-region. Likewise, a “B” parking sign may be posted in a second sub-region indicating that users having a “B” parking permit may park in the second sub-region. The “A” and “B” may correspond to parking permits purchased by or assigned to the users. The users of the parking area may be required to post or display their parking permit to indicate permission to park in the designated area. To enforce proper use of the parking area, parking enforcement must continuously patrol the parking area; individually checking each vehicle is parked in the correct sub-region.

Additionally, in these parking areas it is difficult to know whether a parking space is available and if so, where the available parking space is located. Instead, users of the parking area circle the parking area hoping to find an available parking space.

The parking areas are thus operated inefficiently from a user standpoint as well as an administrator standpoint. Time is wasted by users looking for spots and the administrators expend unnecessary resources paying parking enforcement agents to continuously check and verify parking permits.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example embodiment includes a method including tracking vehicles entering and exiting a parking area based on radio frequency identification (RFID) signals. The RFID signals are received from RFID tags included in the vehicles associated with the parking area. The method also includes determining parking area information associated with the parking area based on the RFID signals. The method further includes providing, via a network, the parking area information to at least one of a parking administrator of the parking area and a user registered to park in the parking area.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A and 1B illustrate example parking areas in which some embodiments may be implemented;

FIG. 2A illustrates a block diagram of an example parking tracking system that may be implemented in the parking areas of FIGS. 1A and 1B;

FIG. 2B illustrates a block diagram of another example parking tracking system that may be implemented in the parking areas of FIGS. 1A and 1B; and

FIG. 3 is a flow chart of an example method of tracking parking in a parking area according to at least one embodiment described herein.

### DESCRIPTION OF EMBODIMENTS

The embodiments discussed herein are related to parking tracking systems. In an example embodiment, passive radio frequency identification (RFID) tags may be installed inside vehicles. The passive RFID tags may be readable by gate modules. In some embodiments, the passive RFID tags may be readable from within about ten meters.

The gate modules may be associated with a parking area and may be installed at vehicle access points (e.g., an entrance or an exit) of the parking area. In some embodiments, the parking area may be separated into sub-regions, with each sub-region having a certain capacity (e.g., a capacity of about one-hundred vehicles). In these and other embodiments, a gate module may be installed at vehicle access points of the sub-regions also.

The gate modules may be configured to receive the RFID signals from the passive RFID tags when an associated vehicle enters or exits the parking area or one of the sub-regions. In some embodiments, the gate modules may be configured to store data included in the RFID signals, such as the name of the user, vehicle identification information and/or time of the entrance or the exit. In these and other embodiments, the gate modules may be configured to send the data included in the RFID signals or parking area information derived therefrom to a central tracking module. The central tracking module may be configured to provide the data or the parking area information to an Internet webpage for display and storage. Some additional embodiments will be explained with reference to the accompanying drawings.

FIGS. 1A and 1B illustrate example parking areas 100A and 100B (collectively, parking areas 100) in which some embodiments may be implemented. The embodiments disclosed herein are generally configured to track use of the parking area 100, to authorize entry to the parking area 100, and to generate parking area information associated with the parking area 100. By tracking the use of the parking area 100, authorizing entry to the parking area 100, and generating parking area information, the parking area 100 may be optimized by users and parking administrator. Additionally, use of the parking area 100 may be automated to reduce costs associated with constant roving parking enforcement.

In the illustrated embodiment of FIG. 1A the first parking area 100A may include parking sub-regions 104A and 104B and in the illustrated embodiment of FIG. 1B, the second parking area 100B may include parking sub-regions 104C and 104D. The parking sub-regions 104A-104D may be referred to generally as sub-region or sub-regions 104. Although specific sub-regions are depicted in FIGS. 1A and 1B, the number of sub-regions for a particular parking area may vary depending on the parking area.

In the illustrated embodiment of FIG. 1A, the first parking area 100A is surrounded by a fence 120, but the parking sub-regions 104A and 104B are not fenced. In contrast to the parking sub-regions 104A and 104B of FIG. 1A, the parking sub-regions 104C and 104D of the second parking area 100B of FIG. 1B in are depicted as being surrounded by a sub-region fence 116A and a sub-region fence 116B, respectively. Other differences between the first parking area 100A and the second parking area 100B are discussed below.

The parking areas 100 are depicted as open-air parking areas for vehicles 102. However, this depiction is not limiting. The parking areas 100 may include parking lots, multiple-level parking structures, underground parking, motorcycle parking, boat slips, a dock, bicycle parking, trailer parking, parking meters on a street, etc. Accordingly, the vehicles 102 may include bikes, motorcycles, trailers, boats, scooters, etc. The embodiments depicted in FIGS. 1A and 1B are described in some detail, however it should be appreciated with the benefit of this disclosure, that the principles discussed with reference to FIGS. 1A and 1B may be applicable in other parking areas 100 and/or with other vehicles 102.

The parking areas 100 include multiple parking spaces 110, some of which are occupied by vehicles 102 and some of which are available. The parking spaces 110 that are occupied with vehicles 102 are not labeled in FIGS. 1A and 1B. Additionally, the parking areas 100 may include one or more reserved parking spaces 112. For example, the parking areas 100 each include four reserved parking spaces 112, two of which are occupied by vehicles 102.

The parking area 100A may also include gate modules 106A and 106B and the parking area 100B may include gate modules 106C and 106D. The gate modules 106A-106D may be referred to generally, as gate module or gate modules 106. The gate modules 106 may be configured to receive entry and exit signals from the vehicles 102. Specifically, each of the gate modules 106 may include a radio frequency identification (RFID) reader. The RFID readers are configured to receive RFID signals from passive RFID tags included in the vehicles 102. In some embodiments, the passive RFID tags may be attached to a windshield or rear-view mirror of a vehicle 102.

Generally, the RFID readers are configured to emit radio waves. When the radio waves emitted from the RFID reader are encountered by a passive RFID tag, a coiled antenna within the passive RFID tag forms a magnetic field. The passive RFID tag draws power from the magnetic field which energizes a circuit in the passive RFID tag. The circuit is configured to transmit an RFID signal from the passive RFID tag that includes information encoded in a memory of the passive RFID tag.

As the vehicles 102 enter and exit the parking areas 100 and/or the sub-regions 104, the vehicles 102 pass within a predefined distance (e.g., about ten meters) of the gate modules 106, and may transmit the RFID signals to the gate modules 106 in response to receiving a reading signal from the RFID readers associated with the gate modules 106. In the second parking area 100B, the gate modules 106 may include physical gates 118A and 118B that may be actuated by the gate modules 106. For example, the gate modules 106 may receive an RFID signal indicating a vehicle 102 is authorized to park in the second parking area 100B or a sub-region 104. Accordingly, the gate module 106 may be configured to lift the physical gate or otherwise allow entry of the vehicle 102. In contrast, the gate modules 106 in the first parking area 100A may not include a physical gate. Thus, reception of the RFID signals may not result in actuation of a physical gate.

The parking areas 100 may include at least one gate module 106 for each of the sub-regions 104 in some embodiments. A determination of a number of gate modules 106 and/or a number of sub-regions 104 may be based, at least partially, on the physical shape of the parking area 100, the size of the parking areas 100, a number of access points of the parking area 100, the predefined distance within which the passive RFID tags are effective, or some combination thereof.

For instance, a large (e.g., five-hundred square meter) parking area 100 may include five gate modules 106 each having a predefined distance of ten meters while a small parking (e.g., 100 square meters) may include a single gate module 106 having the predefined distance of ten meters. As another example, in some embodiments, a gate module 106 may be installed in a relatively close proximity to each access point of the parking areas 100 and/or sub-regions 104 such that the gate modules 106 may use the RFID signals to track the ingress and egress of the vehicles 102 through the access points. Accordingly, the number of gate modules 106 may be based on the number of access points of the parking areas 100 and/or sub-regions 104.

Additionally, in some embodiments, the parking areas 100 may include a central tracking module 108. The central tracking module 108 may be generally configured to receive parking area information, data, RFID signals, etc. (collectively referred to as gate information) from one or more of the gate modules 106. The central tracking module 108 may combine the gate information and/or communicate the gate information to another location such as a server or administrative storage area. Additionally, in some embodiments, the central tracking module 108 may include on or more functionalities of the gate modules 106 or may be included in one of the gate modules 106. Some details of the central tracking module 108 and the gate modules 106 are provided with reference to FIGS. 2A and 2B.

Based at least partially on the RFID signals, the gate modules 106 and/or the central tracking module 108 may determine parking area information associated with the parking area 100. The parking area information may include: an identity of the user (not shown); an identification associated with one or more of the vehicles 102; a map of the parking area 100; a floor plan of the parking area 100, use of a reserved parking space 112 in the parking area 100; availability of a parking space 110 in the parking area 100; a location of an available parking space 110; a number of available parking spaces 110; a time of ingress into the parking area 100 by one of the vehicles 102; a time of egress from the parking area 100 by one of the vehicles 102; authorization of the vehicle 102 to park in the parking area 100; an amount of time that the vehicle 102 has been in the parking area 100; an amount of time that the vehicle 102 is authorized to park in the parking area 100; an expiration of the time that the vehicle 102 is authorized to park in the parking area 100; an expiration of authorization of the vehicle 102 to park in the parking area 100; a location of the vehicle 102 in the parking area; ingress of the vehicle 102 to the parking area 100; egress of the vehicle 102 from the parking area 100; movement of the vehicle 102 within the parking area 100; a location of the vehicle 102 while moving in the parking lot; a location of a specific vehicle 102 (e.g., a specific user's vehicle), or any combination therein.

The gate modules 106 and/or the central tracking module 108 may then provide the parking area information via a network to a parking administrator (not shown) of the parking area 100, a user registered to park in the parking area 100, an Internet webpage (not shown), a mobile device application (not shown), or any combination thereof.

Determination of the parking area information associated with the parking area 100 may include one or more calculations, processes, applications, etc. For example, in some embodiments, the RFID signals may include unique identifiers assigned to users and/or the vehicles 102 associated with the users. When a user drives a vehicle 102 past a first gate module 106A, the first gate module 106A may be configured to read the RFID signal communicated from an RFID tag in the vehicle 102. The RFID signal may include the unique identifier that indicates to the first gate module 106A that the vehicle 102 is associated with the user.

In some embodiments, the unique identifier may associate one of the vehicles 102 with the name, address, registration number, parking authorization, or other information of the user. Thus, the unique identifier may enable verification of an authorization to park in the parking area 100 or sub-region 104. For example, when the RFID signal is received by the gate module 106 and/or the central tracking module 108, the unique identifier may be verified against a database including a list of users and/or vehicles 102 authorized to park in the parking area 100.

Additionally, in embodiments where the unique identifier is associated the users, the RFID signals including the unique identifier may allow for identification of users who are parking in the parking area 100 and/or the sub-region 104. The parking area information may accordingly include identified users of the parking area 100 or sub-region 104.

The unique identifier may be assigned to the user and/or the vehicle 102 when the user registers to park in the parking area 100, for instance. Registration may include a transaction in advance of entering the parking area 100 such as a student registering to park in a parking area 100 at the beginning of a semester or an employee being assigned a parking space 110 in the parking area 100. Alternatively, registration may occur at the time of or immediately prior to when the user desires to park in the parking area 100 such as purchasing a temporary authorization to park in the parking area 100.

Additionally, the gate module 106 and/or the central tracking module 108 may time-stamp received RFID signals. Accordingly, the parking area information may include when each of the vehicles 102 and/or users entered and/or exited the parking area 100 and an amount of time that the vehicles 102 have been in the parking area 100. Additionally, in embodiments in which a parking authorization is temporary, an expiration of the time of the temporary authorization may also be determined.

In some embodiments, the identities of the users of the parking area 100 and the time stamps may be combined to generate parking area information. For example, historical parking behaviors of one or more users may be determined by the unique identifiers and time stamps. Also, which users are parking in the parking area 100 during an event may be determined from the unique identifiers and the time stamps. Further, general occupancy patterns of the parking areas 100 may be determined, such as turnover of parking spaces, occupancy percentage, average parking time, etc.

The RFID signals may be combined with general information about the parking area 100 to determine parking area information. For instance, the general information about the parking area 100 may include a map or a floor plan of the parking area 100. The map or floor plan may indicate a number and/or location of parking spaces 102. In addition, based on the RFID signals a number of vehicles 102 in the parking area 100 may be determined. A number of available parking spaces 102 may be determined by comparing the number of vehicles 102 within the parking area 100 to number of parking spaces 110. The number of available parking spaces 110 may be re-determined whenever a vehicle 102 enters or exits the parking area 100 or may be constantly re-determined in real-time.

In some embodiments, the parking areas 100 may include one or more occupancy sensors 114. The occupancy sensors 114 may be any suitable system, apparatus, or device configured to monitor a parking space of the parking areas 100. For example, an occupancy sensor 114 may be an infrared (IR) sensor configured and positioned to monitor a parking space. The occupancy sensors 114 in the parking areas 100 of FIGS. 1A and 1B are positioned to monitor the reserved parking spaces 112. This depiction is not meant to be limiting. The occupancy sensors 114 may additionally or alternatively be used to monitor the parking spaces 110.

When a vehicle 102 is occupying a reserved space 112, the occupancy sensor 114 may detect the vehicle 102. The occupancy sensor 114 may be configured to communicate an occupancy signal indicating the presence of a vehicle 102 in the reserved parking space 112. For example, the occupancy sensor 114 may communicate the occupancy signal to one of the gate modules 106 and/or the central tracking module 108. The occupancy sensor 114 may communicate the occupancy signal using any suitable manner including via wired or wireless communication.

In some embodiments, the gate module 106 and/or the central tracking module 108 may determine at least some of the parking area information from the occupancy signal. For example, the gate module 106 and/or the central tracking module 108 may determine when reserved parking space 112 in the parking area 100 is being used or has been used and may include this information in the parking area information.

In embodiments in which occupancy sensors 114 are positioned at other parking spaces 110, the occupancy signals may be combined with a determination of a number of available spaces to indicate a number of available parking spaces and precisely which parking spaces are available.

Additionally, in some embodiments, the gate modules 106 and/or the central tracking module 108 may include global positioning system (GPS) capabilities. The GPS capabilities may enable gate modules 106 and/or the central tracking module 108 to locate one or more vehicles 102 using GPS coordinates communicated to the gate modules 106 and/or the central tracking module 108. Based at least partially on the GPS coordinates of the vehicles 102, the locations of one or more of the vehicles 102 and/or location of available parking spaces 110 may be determined. Additionally or alternatively, the GPS coordinates may be combined with RFID signals and/or occupancy signals to determine locations of one or more of the vehicles 102 and/or location of available parking spaces 110.

FIG. 2A illustrates a block diagram of an example parking tracking system 200A. The parking tracking system 200A may be implemented in the parking areas 100 described with reference to FIGS. 1A and 1B. Accordingly, the parking tracking system 200A may include one or more components (e.g., 106 and 108) described with reference to FIGS. 1A and 1B. Some details of the components are not repeated with reference to FIG. 2A.

The parking tracking system 200A includes the gate module 106 configured to receive RFID signals from a passive RFID tag 202, determine parking area information based at least partially on the RFID signals, and provide the parking area information via a network 222 to a user 220 and/or a parking administrator 224.

The gate module 106 may include any suitable mechanism, such as a program, software, function, library, software-as-a-service, analog or digital circuitry, or any combination thereof to perform the functions described herein. For example, the gate module 106 may include a memory 204, a processor 206, a radio frequency (RF) unit 208, an RFID unit 210, a network interface unit 212, a GPS receiving unit 218, a tracking unit 216, and a notifying unit 214.

The processor 206 may be coupled to the memory 204. In some embodiments, the gate module 106 may include logic or instructions resident in the memory 204 for execution by the processor 206. The processor 206 may include, for example, a microprocessor, microcontroller, digital signal processor (DSP), application specific integrated circuit (ASIC), a Field Programmable Gate Array (FPGA), or any other digital or analog circuitry configured to interpret and/or to execute program instructions and/or to process data. In some embodiments, the processor 206 may interpret and/or execute program instructions and/or process data stored in the memory 204.

The memory 204 may include any suitable computer-readable media configured to retain program instructions and/or data for a period of time. By way of example, and not limitation, such computer-readable media may include tangible computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), a specific molecular sequence (e.g., DNA or RNA) or any other storage medium which may be used to carry or store desired program code in the form of computer-executable instructions or data structures and which may be accessed by the processor 206. Combinations of the above may also be included within the scope of computer-readable media. Computer-executable instructions may include, for example, instructions and data that cause a general purpose computer, special purpose computer, or special purpose processing device (e.g., the processor 206) to perform a certain function or group of functions.

The parking tracking system 200A depicts an example embodiment in which the passive RFID tag 202 communicates an RFID signal to the first gate module 106. Specifically, the RFID signal may be communicated to and received by an RFID unit 210 of the gate module 106. In some embodiments, the RFID unit 210 may include an AS3991 RFID reader or another suitable RFID unit.

The gate module 106 may also include the tracking unit 216. The tracking unit 216 may be communicatively coupled to the RFID unit 210. For example, the tracking unit 216 may receive RFID signals from the RFID unit 210. The tracking unit 216 may be coupled to or include the processor 206 and may be configured to determine parking area information from the RFID signal as described above.

For example, the tracking unit 216 may track, based on the RFID signals, ingress to a parking area by one or more of the vehicles, egress from the parking area by the vehicles, and movement of the vehicles within the parking area. Additionally, the tracking unit 216 may determine the parking area information based on the ingress, the egress, and the movement. Additionally still, in embodiments similar to that depicted in FIG. 1B, the tracking unit 216 may be configured to allow ingress of the vehicles into the parking area based on the RFID signals.

The tracking unit 216 may also be configured to provide, via the network 222, the parking area information to the parking administrator 224 and the user 220. The parking administrator 224 may be associated with a specific parking area and the user 220 may be an individual registered to park in the parking area. In this and other embodiments, the tracking unit 216 may be communicatively coupled to the network interface unit 212, which is further coupled to the network 222. The tracking unit 216 provides the parking area information to the network interface unit 212, which in turn provides the parking area information to the network 222.

The network interface unit 212 may include any suitable system, apparatus, or device configured to interface with the network 222. For example, in some embodiments, the network interface unit 212 may include a wireless fidelity (Wi-Fi) network interface such as a Microchip Rn171. Alternatively, the network interface unit 212 may include any wired or wireless network interface. Likewise, the network 222 may include any wireless or wired technology and/or any combination of devices that combine to create a network suitable for the functions described herein.

The GPS receiving unit 218 may receive GPS coordinates or other GPS data from the vehicle 102. The GPS coordinates or other GPS data may indicate the location of a vehicle. The GPS receiving unit 218 may be communicatively coupled to the tracking unit 216 such that the tracking unit 216 may determine parking area information at least partially based on the GPS coordinates or other GPS data.

The RF unit 208 may be used to communicate one or more RF signals. For example, the RF unit 208 may include an RF transceiver such as a CC 1100 that can communicate with the parking administrator, another gate module (not shown), or a central tracking module (not shown), for instance. Additionally, in some embodiments, the RF unit 208 may be configured to receive occupancy information from one or more of the occupancy sensors 114. The RF unit 208 may be communicatively coupled to the tracking unit such that the tracking unit may determine occupancy information associated with one or more parking spaces (e.g., reserved spaces 112) based on occupancy information received from the occupancy sensors 114. In these and other embodiments, the tracking unit 216 may be configured to receive occupancy signals from the occupancy sensors 114 via any other suitable communication (e.g., via a wired connection).

The notifying unit 214 may be communicatively coupled to the tracking unit 216 and may communicate notifications to the parking administrator 224 and/or the user 220 based on the parking area information. For example, if the vehicle 102 is not authorized to enter the parking area, then the notification unit 214 may notify the parking administrator 224. In addition, if the user 220 has a temporary authorization to use a parking area and temporary authorization is about to expire, then the notification module 214 may notify the user 220.

FIG. 2B illustrates a block diagram of another example parking tracking system 200B. The parking tracking system 200B may be implemented in the parking areas 100 described with reference to FIGS. 1A and 1B and may be a more complex example of the parking tracking system 200A described with reference to FIG. 2A. Accordingly, the parking tracking system 200B includes one or more components (106 and 108) described with reference to FIGS. 1A and 1B and one or more components (202, 220, 222, and 224) described with reference to FIG. 2A. Some details of these components are not repeated with reference to FIG. 2B.

The central tracking module 108 may include any suitable mechanism, such as a program, software, function, library, software-as-a-service, analog or digital circuitry, or any combination thereof to perform the functions described herein. For example, the central tracking module 108 may include a memory 236 and a processor 238, which may be independent components or integrated into one or more of a RF unit 240, RFID unit 242, GPS receiving unit 246, a network interface unit 244, a tracking unit 248, a notifying unit 250, or a payment unit 252.

The processor 238 may be coupled to the memory 236. In some embodiments, the central tracking module 108 may be include logic or instructions resident in the memory 236 for execution by the processor 238. The processor 238 may include, for example, a microprocessor, microcontroller, digital signal processor (DSP), application specific integrated circuit (ASIC), a Field Programmable Gate Array (FPGA), or any other digital or analog circuitry configured to interpret and/or to execute program instructions and/or to process data. In some embodiments, the processor 238 may interpret and/or execute program instructions and/or process data stored in the memory 236.

The memory 236 may include any suitable computer-readable media configured to retain program instructions and/or data for a period of time. By way of example, and not limitation, such computer-readable media may include tangible computer-readable storage media including RAM, ROM, EEPROM, CD-ROM or other optical disk storage, magnetic disk storage or other magnetic storage devices, flash memory devices (e.g., solid state memory devices), a specific molecular sequence (e.g., DNA or RNA) or any other storage medium which may be used to carry or store desired program code in the form of computer-executable instructions or data structures and which may be accessed by the processor 238. Combinations of the above may also be included within the scope of computer-readable media. Computer-executable instructions may include, for example, instructions and data that cause a general purpose computer, special purpose computer, or special purpose processing device (e.g., the processor 238) to perform a certain function or group of functions.

The parking tracking system 200B may include multiple gate modules 106 (in FIG. 2B “first gate module 106A” and “second gate module 106B”) configured to receive RFID signals from passive RFID tags 202A-202D. The gate modules 106 may also be configured to receive occupancy information from one or more of the occupancy sensors 114. The gate modules 106 are substantially similar to and/or may correspond to the gate modules 106 described with reference to FIGS. 1A-2A. The gate modules 106 in the parking tracking system 200B may be configured to communicate the RFID signals and/or parking area information based on the RFID signals, GPS signals, occupancy signals etc. (collectively, gate information) to the central tracking module 108. In some embodiments, the communication of the gate information may be via the RF unit 208 included in the gate modules 106 and may be received by the central tracking module 108 in the RF unit 240 included therein.

The RF unit 240 in the central tracking module 108 may receive the gate information from multiple gate modules 106 and may communicate update information between the gate modules 106 such as parking authorization updates. The gate information and the update information may additionally or alternatively be communicated via other communicative coupling such as a Wi-Fi interface or a wired communication interface. Additionally, in some embodiments, the gate modules 106 may be configured to communicate with the central tracking module 108 via the network 222.

The central tracking module 108 may be configured to receive the gate information from multiple gate modules 106. In some embodiments, the central tracking module 108 includes the tracking unit 248 that is substantially similar to the tracking unit 216 included in the gate modules 106. The tracking unit 248 may be configured to derive or calculate parking area information from the gate information. Additionally, the central tracking module 108 may include the RFID unit 242 and/or the GPS receiving unit 246 which are substantially similar to the RFID unit 210 and the GPS receiving unit 218 included in the gate modules 106. The RFID unit 242 and/or the GPS receiving unit 246 may receive RFID signals or GPS data that may be combined with the gate information to derive or calculate parking area information by the tracking unit 248. Additionally, in some embodiments, the RF unit 240 may be configured to receive occupancy signals from one or more occupancy sensors 114.

The parking area information may be provided to the parking administrator 224 and/or the user 220 via the network 222. The central tracking module 108 may implement a network interface module 244 to access and communicate via the network 222.

In some embodiments, the parking area information is additionally communicated to a webserver 232 that hosts an Internet webpage 234 and to one or more mobile devices 228 for display on a mobile device application 230. In some embodiments, the webserver 232 may be configured to communicate the parking area information to the mobile device application 230. Additionally, the user may be able to access the parking area information via any other device that may access the webserver via the Internet. The mobile device 228 may include a smart phone, tablet personal computer, laptop computer, or any device with mobile capabilities and the capability to run the mobile device application 230 described herein. The webserver 232 may include a server or a collection of servers configured to receive input and information, host the information on one or more webpages, and make the webpages accessible.

In some embodiments, the parking area information may be first provided to the parking administrator 224 then to the mobile device application 230 and the Internet webpage 234. Alternatively, the parking area information may be communicated to the webserver 232 that updates the mobile device application 230. In these and other embodiments, the mobile device application 230 may be a simplified version of the Internet webpage 234 that may be customized for the user 220.

The parking area information may be displayed to the user 220 and/or the parking administrator 224 on the Internet webpage 234 and/or the mobile device application 230. For example, the Internet webpage 234 and/or the mobile device application 230 may display a total number of parking spaces, the location of a vehicle of the user 220, the amount of time the vehicle of the user 220 has been in a parking area, a map of a parking area, and locations of available parking spaces, the location of other vehicles moving in the parking area, the location of another user's vehicle (e.g., a friend's vehicle, as described below) or any other parking area information.

The user 220, other users, and the administrator 224 may have access to different parking area information. For example, the administrator 224 may view each vehicle in a parking area and the user associated with each vehicle. The user 220 may only view parking area information relevant to the user 220. The user 220 may additionally have access to advertisements and/or have a voice recognition interface for ease of use.

Additionally, the Internet webpage 234 and/or the mobile device application 230 may enable the user 220 to interact with the parking tracking system 200B and/or the parking administrator 224. Specifically, the user 220 may submit payments (e.g., through a student account associated with the user 220 when the user 220 is a student of a university and the parking area is associated with the university), purchase a parking authorization, receive individual or general notifications, reserve a parking space, or some combination thereof via the Internet webpage and/or mobile device application 230. One or more of the interactions may occur via the voice recognition interface.

For example, the user 220 may purchase a temporary authorization via the Internet webpage 234 (e.g., using the mobile device application 230). Some verification of the temporary authorization may be received by a payment unit 252 and/or by the parking administration 224. The central tracking module 108 may communicate the parking authorization to the gate modules 106. When the user 220 enters a parking area, the gate module 106 recognizes that the user 220 has a temporary authorization and accordingly allows the user 220 to enter the parking area. Additionally, while the user 220 is parked in the parking area, the user 220 may monitor the time remaining for the temporary authorization. Within a predetermined time of expiration of the temporary authorization, the notification unit 214 may communicate a notification to the user 220 that indicates an approaching expiration time. The user 220 may then purchase additional time via the Internet webpage 234 and/or the mobile device application 228. The payment may be submitted to the payment unit 252 and a re-authorization may be communicated to the gate modules 106.

As another example, the user 220 may access the parking area information via the Internet webpage 234 (e.g., using the mobile device application 230) to determine which parking spaces may be available. In some of these embodiments, the user 220 may reserve one of the available parking spaces via the Internet webpage 234. In these and other embodiments, the accessed parking area information may include city maps that may include the parking area 100 and/or a floor plan of the parking area 100. The maps may indicate the available parking spaces. Additionally, in some embodiments, directions to the available parking spaces may be given.

Further, in some embodiments, the user 220 may access the parking area information to determine where other moving vehicles may be located in the parking area 100, which may indicate that the moving vehicles may be intending to park in the area where the vehicles are located. Therefore, the user 220 may search for parking in a different section of the parking area 100. Additionally, the moving vehicle information may indicate an area where a parking space has recently been vacated by a vehicle that may now be moving.

Further, in some embodiments, the user 220 may have a friend that is also registered to park in the parking area 100 and the friend may give the user 220 permission to access parking information associated with the friend's vehicle (e.g., where in the parking area 100 that the friend's vehicle is parked). As such, the parking information viewed by the user 220 may indicate the friend's vehicle information such that, for example, the user 220 may find an available parking space that is near where the friend's vehicle is parked.

As another example, the Internet webpage 234 may allow the user 220 to communicate with the parking administrator 224 such that, in some embodiments, the user 220 may communicate information to the parking administrator 220. For example, the user 220 may inform the parking administrator 224 of an unauthorized vehicle parked in a space reserved by the user 220. Additionally, the user 220 may inform the parking administrator 224 of any other information that may be applicable to the parking area 100 such as maintenance issues, crime issues, etc.

Additionally, the parking tracking system 200B may be used to enforce authorized use of a parking area. The central tracking module 108 may notify the parking administrator 224 and/or a parking enforcement agent 226 when unauthorized use of a parking area is detected (i.e., an unauthorized vehicle is parked in the parking area). When the parking administrator 224 is notified, the parking administrator 224 may further notify the parking enforcement agent 226.

For example, if the passive RFID tag of an unauthorized user or unauthorized vehicle is detected, the central tracking module 108 may notify the parking enforcement agent 226 via the network 222. Specifically, the notifying unit 250 may transmit a notification via the network interface unit 244, through the network 222 to the parking enforcement agent 226. The parking enforcement agent 226 may issue the unauthorized user a parking ticket, may notify the authorized user via the mobile device application 230 or the Internet webpage 234 (and/or allow payment to the payment unit 252), or may dispatch an agent to physically interact with the unauthorized user or unauthorized vehicle.

In some embodiments, when the user 220 purchases temporary parking authorization, the notifying unit 250 may notify the user 220 and the parking enforcement agent 226 within predetermined times of the expiration of the temporary authorization. For example, the notifying unit 214 may communicate a notification to the user 220 ten minutes prior to the expiration time and may communicate a notification to the parking enforcement agent 226 five minutes following the expiration time.

The parking administrator 224, the webserver 232, the central tracking module 108, or another remote storage device (not shown) may track or store the parking area information determined by the parking tracking system 200B. For example, the access points, parking authorizations for the users, statistics about different parking areas, transactional records of the users, or any combination thereof may be stored. The parking area information may be used to track long-term use and to predict future use of a parking area, for instance.

Therefore, the parking tracking systems 200 may be configured to improve administration of parking with the parking areas 100. Modifications, additions, or omissions may be made to the tracking systems and parking areas without departing from the scope of the present disclosure. For example, the number of gate modules, central tracking modules, parking spaces, etc., of FIGS. 1A, 1B, 2A, and 2B are for illustrative purposes only and may vary depending on the particular application. Additionally, the distinction between modules and individual units within the modules are merely to facilitate an understanding of operations that may be performed by the parking tracking systems 200. As such, in practice the modules and/or units may be combined or separated in a manner different from that depicted.

FIG. 3 is a flow chart of an example method 300 of tracking parking in a parking area according to at least one embodiment described herein. The method 300 may be implemented by the parking tracking systems 200A and 200B described with reference to FIGS. 2A and 2B. Although illustrated as discrete blocks, various blocks may be divided into additional blocks, combined into fewer blocks, or eliminated, depending on the desired implementation.

The method 300 may begin at 302 by tracking vehicles entering and exiting a parking area based on radio frequency identification (RFID) signals received from RFID tags included in the vehicles associated with the parking area. The RFID signals may include a unique identifier assigned to at least one of the user and a vehicle associated with the user.

At 304, the method 300 may include determining parking area information associated with the parking area based on the RFID signals. In embodiments in which the RFID signals include the unique identifiers, the information associated with the parking area may be determined based on the unique identifier.

The parking area information may include: an identity of the user; an identification associated with the vehicle, a map of the parking area; a floor plan of the parking area; use of a reserved parking space in the parking area; availability of a parking space in the parking area; a location of an available parking space; a number of available parking spaces; a time of ingress into the parking area by a vehicle; a time of egress from the parking area by the vehicle; authorization of the vehicle to park in the parking area; an amount of time that the vehicle has been in the parking area; an amount of time that the vehicle is authorized to park in the parking area; an expiration of the time that the vehicle is authorized to park in the parking area; an expiration of authorization of the vehicle to park in the parking area; a location of the vehicle in the parking area; ingress of the vehicle to the parking area; egress of the vehicle from the parking area; movement of the vehicle within the parking area; a location of the vehicle moving in the parking lot; a location of a specific vehicle (e.g., a specific user's vehicle), or any combination therein.

At 306, the method 300 may include providing, via a network, the parking area information to a parking administrator of the parking area and/or a user registered to park in the parking area. More particularly, in some embodiments, the information may be provided via an Internet webpage and/or a mobile device application.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For instance, based on the parking area information a parking enforcement agent may be notified of an unauthorized vehicle parked in the parking area.

Additionally or alternatively, the method 300 may include receiving GPS data associated with one or more of the vehicles located in the parking area. The GPS data may be included in the information associated with the parking area.

Additionally or alternatively, the method 300 may include tracking, based on the RFID signals, an ingress to the parking area by the vehicles, egress from the parking area by the vehicles, and movement of the vehicles within the parking area. The parking area information may be determined based on the ingress, the egress, the movement, or any combination thereof.

Additionally or alternatively, the method 300 may include notifying, via the network, the user of an expiration time of a temporary parking authorization for parking in the parking area. The method 300 may further include extending the expiration time based on a payment submitted by the user via the network.

Additionally or alternatively, the method 300 may include allowing ingress of the vehicles into the parking area based on the RFID signals. For example, a gate module may include a physical gate that may be actuated based on the RFID signals.

The embodiments described herein may include the use of a special purpose or general-purpose computer including various computer hardware or software modules, as discussed in greater detail below.

As indicated above, embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may comprise non-transitory computer-readable storage media including RAM, ROM, EEPROM, CD-ROM or other optical disk storage, magnetic disk storage or other magnetic storage devices, or any other non-transitory storage medium which may be used to carry or store desired program code means in the form of computer-executable instructions or data structures and which may be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
tracking vehicles entering and exiting a parking area based on radio frequency identification (RFID) signals received from RFID tags included in the vehicles associated with the parking area;
determining parking area information associated with the parking area based on the RFID signals; and
providing, via a network, the parking area information to at least one of a parking administrator of the parking area and a user registered to park in the parking area.

2. The method of claim 1, wherein the parking area information includes at least one of: an identity of the user; a map of the parking area; a floor plan of the parking area; use of a reserved parking space in the parking area; availability of a parking space in the parking area; a location of an available parking space; an identification associated with one or more of the vehicles; a number of available parking spaces; a time of ingress into the parking area by the one or more vehicles; a time of egress from the parking area by the one or more vehicles; authorization of the one or more vehicles to park in the parking area; an amount of time that the one or more vehicles have been in the parking area; an amount of time that the one or more vehicles are authorized to park in the parking area; an expiration of the time that the one or more vehicles are authorized to park in the parking area; an expiration of authorization of the one or more vehicles to park in the parking area; a location of the one or more vehicles in the parking area; ingress of the one or more vehicles to the parking area; egress of the one or more vehicles from the parking area; movement of the one or more vehicles within the parking area; a location of the one or more vehicles moving within the parking area; and a location of a specific vehicle within the parking area.

3. The method of claim 2, wherein the specific vehicle is the user's vehicle.

4. The method of claim 2, wherein the specific vehicle is a friend of the user's vehicle.

5. The method of claim 1, further comprising notifying, based on the parking area information, a parking enforcement agent of an unauthorized vehicle parked in the parking area.

6. The method of claim 1, further comprising:
receiving a user RFID signal that includes a unique identifier assigned to at least one of the user and a vehicle associated with the user; and
determining the information associated with the parking area based on the unique identifier.

7. The method of claim 1, further comprising:
receiving global positioning satellite (GPS) data associated with one or more of the vehicles located in the parking area; and
including the GPS data in the information associated with the parking area.

8. The method of claim 1, further comprising providing the information via at least one of an Internet webpage and a mobile device application.

9. The method of claim 1, further comprising:
tracking, based on the RFID signals, at least one of ingress to the parking area by the vehicles, egress from the parking area by the vehicles, and movement of the vehicles within the parking area; and
determining the information based on at least one of the ingress, the egress, and the movement.

10. The method of claim 1, further comprising notifying, via the network, the user of an expiration time of a temporary parking authorization for parking in the parking area.

11. The method of claim 10, further comprising extending the expiration time based on a payment submitted by the user via the network.

12. The method of claim 1, further comprising determining occupancy of a particular parking space of the parking area based on input from an occupancy sensor.

13. The method of claim 1, further comprising reserving a parking space for the user in response to a reservation request from the user.

14. A system comprising:
a radio frequency identification (RFID) reader configured to receive RFID signals from RFID tags included in vehicles entering and exiting a parking area; and
a tracking unit communicatively coupled to the RFID reader and configured to:
determine parking area information associated with the parking area based on the RFID signals; and
provide, via a network, the parking area information to at least one of a parking administrator of the parking area and a user registered to park in the parking area

15. The system of claim 14, wherein the parking area information includes at least one of: an identity of the user; a map of the parking area; a floor plan of the parking area; use of a reserved parking space in the parking area; availability of a parking space in the parking area; a location of an available parking space; a number of available parking spaces; a time of ingress into the parking area by a vehicle; an identification associated with one or more of the vehicles; a time of egress from the parking area by the vehicle; authorization of the vehicle to park in the parking area; an amount of time that the vehicle has been in the parking area; an amount of time that the vehicle is authorized to park in the parking area; an expiration of the time that the vehicle is authorized to park in the parking area; an expiration of authorization of the vehicle to park in the parking area; a location of the vehicle in the parking area; ingress of the vehicle to the parking area; egress of the vehicle from the parking area; movement of the vehicle within the parking area; a location of the one or more vehicles moving within the parking area; and a location of a specific vehicle within the parking area.

16. The system of claim 15, wherein the specific vehicle is the user's vehicle.

17. The system of claim 15, wherein the specific vehicle is a friend of the user's vehicle.

18. The system of claim 14, further comprising a notification unit communicatively coupled to the tracking unit and configured to notify a parking enforcement agent of an unauthorized vehicle parked in the parking area.

19. The system of claim 14, wherein:
the RFID signals include unique identifiers assigned to at least one of the user and a vehicle associated with the user; and
determining the parking area information based on the unique identifier.

20. The system of claim 14, further comprising:
a global positioning satellite (GPS) receiving unit configured to receiving GPS data associated with one or more of the vehicles located in the parking area; and to include the GPS data in the parking area information.

21. The system of claim 14, wherein the tracking unit provides the information via at least one of an Internet webpage and a mobile device application.

22. The system of claim 14, wherein the tracking unit is further configured to track, based on the RFID signals, at least one of ingress to the parking area by the vehicles, egress from the parking area by the vehicles, and movement of the vehicles within the parking area; and
determine the information based on at least one of the ingress, the egress, and the movement.

23. The system of claim 14, further comprising a notifying unit configured to notify the user of an expiration time of a temporary parking authorization for parking in the parking area via the network.

24. The system of claim 23, wherein the tracking unit is configured to extend the expiration time based on a payment submitted by the user via the network.

25. The system of claim 14, wherein the tracking unit is further configured to determine occupancy of a particular parking space of the parking area based on input from an occupancy sensor.

26. The system of claim 14, further comprising reserving a parking space for the user in response to a reservation request from the user
